(19) United States
(12) Patent Application Publication
(10) Pub. No.: US 2009/0172952 A1
(43) Pub. Date: Jul. 9, 2009

(54) Non-stick coated putty knife

(76) Inventors: Brandon Cory Hoover, Cornelius, NC (US); John Paul Marcantonio, Charlotte, NC (US); Tim Young, Snellville, GA (US)

Correspondence Address: TAFT, STETTINIUS & HOLLISTER LLP, SUITE 1800, 425 WALNUT STREET, CINCINNATI, OH, 45202-3957, US

(21) Appl. No.: 11/824,547

(22) Filed: Jun. 29, 2007

(51) Int. Cl. B26B 3/00; B25G 3/00

(52) U.S. Cl. 30/169; 30/345

(57) ABSTRACT

A putty knife coated with a non-stick coating, such as a flurorpolymer, that integrates the non-stick surface properties into the knife thereby making the knife easier to clean and better for applying/removing materials.

### CROSS REFERENCE TO RELATED APPLICATIONS

This application claims priority to co-pending U.S. Provisional Application Ser. No. 60/081,026 entitled Non-Stick Coated Putty Knife filed Jun. 29, 2006, the entire contents of which are hereby incorporated by reference.

### FIELD OF THE INVENTION

The present invention is directed to putty knifes and the like for use in connection with scraping and applying applications.

### BACKGROUND

Specific materials such as plastics, carbon steels, spring steels, and aluminum have been used in the past for putty knife and similar tools but have generally not performed as well as could be desired. In particular, prior art putty knifes, blades, tools etc. had functionality difficulties due to the fact that they were difficult to clean following use. What is desired is a putty knife or tool that is easier to clean following use.

### SUMMARY OF THE INVENTION

The present invention provides a putty knife and or tool coated with a non-stick coating, such as a flurorpolymer or Teflon that integrates the non-stick surface properties into the knife, thus not requiring alternative solutions to clean. The blade of the putty knife or tool (typically made of metal or plastic) surface will preferably be coated in the non-stick surface, such as Teflon, or a similar material. The handle portion of the product (typically plastic, metal, or other) may also be coated in and/or include impregnated non-stick material such as a fluoropolymer or Teflon. The invention allows the user to work faster by decreasing the time and extra tools required to clean the putty knife following use.

### BRIEF DESCRIPTION OF THE DRAWINGS

The invention will become more fully understood from the following detailed description, taken in conjunction with the accompanying drawings.

FIG. 1 is a perspective view of a putty knife in accordance with one embodiment of the present invention.

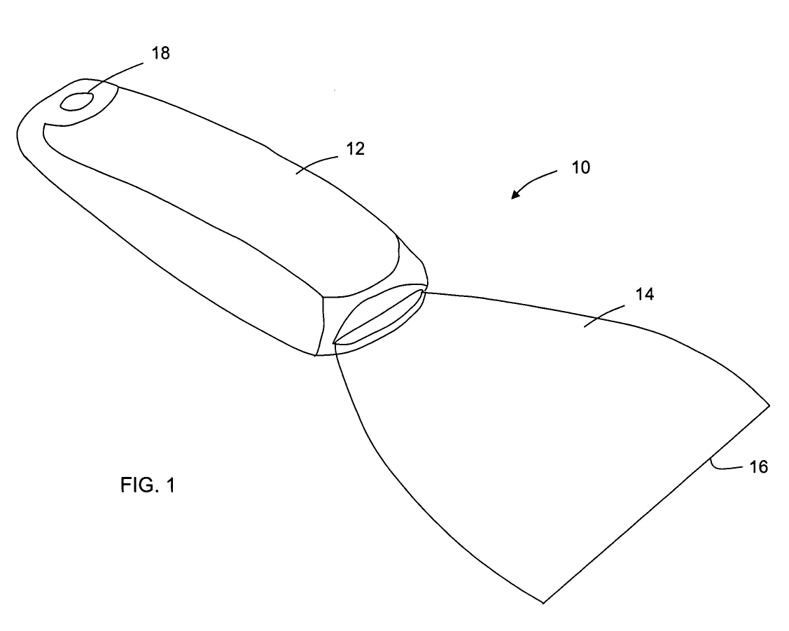

### DETAILED DESCRIPTION

The putty knife 10 is preferably comprised of a handle 12 and a blade 14. The blade 14 of the putty knife 10 is typically made of metal or plastic is preferably coated in a non-stick coating, such as Teflon, or a similar material. The handle portion 12 of the putty knife (typically made of a plastic, metal, rubber, etc.) may also be coated in and/or The present invention provides a putty knife 10 coated with a non-stick coating, such as a flurorpolymer or Teflon that integrates the non-stick surface properties into the knife 10, thus not requiring alternative solutions to clean. include impregnated non-stick material such as a fluoropolymer or Teflon. The handle 12 may preferably include a hole 18 therein for facilitating display, storage of the putty knife 10. The coated putty knife 10 allows the user to work faster by decreasing the time and extra tools required to clean the putty knife 10 following use. Additional benefits include faster application and smoother application of finishes using the putty knife 10 and/or removal of finishes using the putty knife 10.

Non-stick coatings may be applied in the following non-limiting manners. For the blade 14: a spray on Teflon or other similar non-stick coating may be applied before the product has been cut to shape and the cutting edges 16 applied or thereafter. For the handle 12: Teflon or other non-stick coating may be added into the resin as a powder before the product is injection molded or coated on the surfaces thereafter. Alternatively, the entire putty knife 10, including the handle 12 and blade 14 could receive a spray coating of a Teflon or similar material. Alternative non-stick coating materials which may be used include, but are not limited to, the following: non-stick fluoropolymer resins or inorganic dry lubricants; polytetrafluoroethylene (PTFE); fluorinated ethylenepropylene (FEP); polyvinylidene fluoride (PVDF); perfluoroalkoxy (PFA); ethylene chlorotrifluoroethylene (ECTFE); molybdenum disulfide (MoS2); and blends thereof. Many of these coatings are available commercially under the Teflon® trademark. The non-stick solutions can further comprise conventionally known film-formers to produce composite non-stick coatings of superior performance. These coatings may be applied as is known in the art. The coating may be applied via spraying, dipping or any other method as is known to those of ordinary skill in the art. Preferably the coating is baked on in order to improve the adhesion thereof.

Additionally within the scope of the invention is the use of a plastic for the knife blade 12 and or handle 14 having a non-stick material, such as a fluoropolymer, impregnated therein. The plastic may be injection molded, thermoformed, vacuumformed, or formed in any other method known in the art into the desired shape. Additionally, plastics could be used that have the non-stick coating applied to the plastic after the plastic is formed into the desired handle 12 shape. Also within the scope of the invention is the use of a plastic or metal sheet having a non-stick coating, such as a fluoropolymer, applied to a sheet prior to stamping the sheet into the desired putty knife 10 shape.

Application of the non-stick coating may be accomplished as follows. Preferably the substrate (metal or plastic) to be coated is cleaned using normal industrial practices as is known in the art, such as chemical washes or solvent cleaning and degreasing. After cleaning, the substrate to be coated and used to form the tool in accordance with the invention is preferably handled with gloves to prevent fingerprint contamination of the substrate. Preferably, the substrate is preheated to the baking temperature to remove traces of oil and other contaminants, especially when the substrate is porous. In a preferred embodiment, the substrate may be grit blasted to improve adhesion of the coating. Wheel sanding, wire brushing, sanding, directional grinding and chemical etching may also be used.

The following application procedures can be used to apply the non-stick coatings discussed herein in accordance with the present invention. Of course, other application methods as conventionally known in the art also would be operable and are considered within the scope of the invention as well. In particular, standard industrial compressed air spray equipment may be used to spray the non-stick coating on the substrate. Suction, gravity or pressure type spray equipment are also considered operable. Preferably, distance from the gun to the substrate is between approximately 2-14 inches. If the gun is too close, the finish may look rippled and if it is too far, the spray may look dry and rough.

Electrostatic guns or discs are suitable for the application of non-stick coatings in accordance with the invention. The advantages of electrostatic application include better film uniformity and potential savings in material, due to the reduction in overspray. Airless spray and powder coating techniques may also be used in the manner as is known to those of ordinary skill in the art. Furthermore, dip and flow coating techniques, roller coating techniques, and even brush techniques may be useful in certain situations. Depending on the thickness of the coating to be applied, it may be desired to apply multiple coats of the non-stick coating

In a preferred embodiment, the non-stick coating is heat cured to achieve a strong bond with the substrate. Reaching and maintaining proper cure temperatures for a sufficient period of time to sinter, melt flow or set the film helps insure the best coating. For coatings which are primarily PTFE, PFA and FEP fluoropolymers, no film formation may take place below certain minimum temperatures and thus it is important to maintain proper bake times and temperatures in order to get the desired coating performance. For non-stick coatings which contain organic binders in addition to the fluoropolymer resins, there usually is a greater range of possible cure temperatures and times in order to achieve a desired film property. Still, excessive bake times and/or temperatures may degrade the binder, causing discoloration, film embrittlement and/or loss of adhesion.

Any commonly used type of industrial oven, batch or conveyor, may be used for curing fluoropolymer non-stick coatings in accordance with the present invention. This is because fluoropolymer coatings are rarely affected by the combustion products of coal or natural gas. Infrared and convection ovens may also be used effectively. Factors which may affect total bake time include the following: residence time in the oven; heat capacity of the oven; mass and thermal conductivity of the substrate; air circulation; oven air temperature; percent of substrate covered by the non-stick coating; load of work in the oven; weight to surface area ratio, etc.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A putty knife comprising:
a blade,
a handle,
a non-stick coating on said blade.

2. The putty knife of claim 1 wherein said non-stick coating is a fluoropolymer.

3. The putty knife of claim 1 wherein said blade is only partially coated in a non-stick coating.

4. The putty knife of claim 1 wherein said blade is comprised of a metal substrate and said handle is comprised of a non-metal substrate.

5. The putty knife of claim 1 wherein said blade includes a cutting edge and a width of said cutting edge is at least two times as wide as a width of said handle.

6. The putty knife of claim 1 wherein said handle is comprised of a non-metal substrate and said handle is impregnated with a non-stick material.

7. The putty knife of claim 6 wherein said non-stick material is a fluoropolymer.

8. A putty knife comprising:
a metal blade,
a non-metal handle,
said metal blade including a cutting edge thereon having a width at least two times as wide as said handle; and
a non-stick coating applied on said blade.

9. The putty knife of claim 8 further comprising a non-stick coating applied on said handle.

10. The putty knife of claim 8 wherein said non-stick coating is a fluoropolymer

11. The putty knife of claim 9 wherein said non-stick coating is a fluoropolymer.

12. The putty knife of claim 8 wherein said handle further comprises a through-hole therein located proximate an upper extent thereof.

13. The putty knife of claim 8 wherein said handle includes a non-stick material impregnated therein.

14. The putty knife of claim 13 wherein said non-stick material is a fluoropolymer.

15. A putty knife comprising:
a metal blade including a fluoropolymer coating thereon and including a cutting edge;
a non-metal handle having a through-hole therein located proximate an upper extent thereof;
wherein said cutting edge of said blade is at least two times as wide as a width of said handle.
